(19) United States
(12) Patent Application Publication
(10) Pub. No.: US 2021/0406303 A1
(43) Pub. Date: Dec. 30, 2021

(54) SYSTEM AND METHOD FOR GENERATING REALISTIC USAGE DATA OF IN-VEHICLE INFOTAINMENT

(71) Applicant: Robert Bosch GmbH, Stuttgart (DE)

(72) Inventors: Hyeongsik KIM, San Jose, CA (US); Lu ZHOU, Manhattan, KS (US); Monireh EBRAHIMI, Manhattan, KS (US)

(21) Appl. No.: 16/912,813

(22) Filed: Jun. 26, 2020

(51) Int. Cl. G06F 16/635; G06F 16/687; G06F 16/65; G06N 20/00; B60K 35/00

(52) U.S. Cl. CPC G06F 16/635; G06F 16/687; B60K 2370/164; G06N 20/00; B60K 35/00; G06F 16/65

(57) ABSTRACT

A method for generating synthetic in-vehicle infotainment data includes receiving a plurality of preference data, wherein the preference data is associated with a plurality of domains associated applications in the in-vehicle infotainment system, receiving information related to an age or gender of a user of the in-vehicle infotainment systems, utilizing the plurality of preference data and the information related to the age or gender of the user to generate one or more user profiles associated with the in-vehicle infotainment system, and outputting a synthetic dataset to be utilized in a recommendation system of the in-vehicle infotainment system utilizing the one or more user profiles, wherein the synthetic dataset is associated with the one or more user profiles.

### TECHNICAL FIELD

The current disclosure relates to infotainment systems, including those found in vehicles.

### BACKGROUND

An in-vehicle infotainment system may include a collection of hardware and software in automobiles that provides audio or video entertainment, including radios, CD players, video players, navigation system, USB and Bluetooth connectivity, Wi-Fi and so on. The system provides a human machine interface that can be controlled by a user to set up the configuration of the system based on his/her individual preference.

### SUMMARY

According to one embodiment, a method for generating synthetic in-vehicle infotainment data includes receiving a plurality of preference data, wherein the preference data is associated with a plurality of domains associated applications in the in-vehicle infotainment system, receiving information related to an age or gender of a user of the in-vehicle infotainment systems, utilizing the plurality of preference data and the information related to the age or gender of the user to generate one or more user profiles associated with the in-vehicle infotainment system, and outputting a synthetic dataset to be utilized in a recommendation system of the in-vehicle infotainment system utilizing the one or more user profiles, wherein the synthetic dataset is associated with the one or more user profiles.

According to a second embodiment, a computer-implemented method of generating a dataset for an in-vehicle infotainment system includes receiving information related to a model or make of a vehicle utilizing the in-vehicle infotainment system, receiving usage data associated with an in-vehicle infotainment system, receiving a plurality of preference data, wherein the preference data is associated with a plurality of domains, utilizing the plurality of preference data and usage data to generate one or more user profiles associated with the in-vehicle infotainment system, and outputting a synthetic dataset to be utilized in a recommendation system of the in-vehicle infotainment system utilizing the one or more user profiles.

According to a third embodiment, a method of generating a synthetic dataset for an in-vehicle infotainment system includes receiving information related to a model or make of a vehicle utilizing the in-vehicle infotainment system, receiving usage data associated with an in-vehicle infotainment system, receiving a plurality of preference data from a plurality of remote servers not connected to the in-vehicle infotainment system, wherein the preference data is associated with a plurality of domains, utilizing the plurality of preference data and usage data to generate one or more user profiles associated with the in-vehicle infotainment system, and outputting a synthetic dataset to be utilized in a recommendation system of the in-vehicle infotainment system utilizing the one or more user profiles.

### BRIEF DESCRIPTION OF THE DRAWINGS

FIG. 1 illustrates the overall architecture implemented by the system

FIG. 2 is an overview of the characteristics of log data.

FIG. 3 illustrates an example process of related data and background knowledge collection and analysis.

FIG. 4 discloses an example of a method of data integration and user profile generation.

FIG. 5 illustrates the process of labelling process and agreement score calculation.

FIG. 6 illustrates an overview of a synthetic in-vehicle infotainment data.

FIG. 7 is a simplified block diagram of a testing platform according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The current disclosure relates to a system and method for modeling and generating realistic usage data of users for evaluating in-vehicle infotainment (IVI). IVI is a collection of hardware and software in automobiles that provides audio or video entertainment. Generally, as a part of a development life cycle of IVI, developing the new types of IVI involves the step that conducts several tests to ensure that development meets the requirements and satisfaction of users. While performing the tests often needs the usage data of the IVI systems, such data may not be readily available because sometimes the target IVIs can include new features which may not exist before in other systems or the test users may not want to share their data due to the concerns about privacy disclosure. Therefore, to enable the effective evaluation of the IVI, it is essential to develop a data generation system for IVI, which can establish generalized synthetic data and cover composite information from various domains. In this report, we propose the system that can generate realistic behavioral logs of users based on the methodologies we developed, which consists of the steps that (i) conduct the requirement and characteristics analysis of log data, (ii) collect relevant realistic source data and background knowledge from various domains and analyze user behaviors via data mining and statistical models, (iii) integrate learned knowledge and user behavior patterns to generate user profiles and behavioral logs, and finally (iv) validate the correctness and the quality of generated synthetic data

A user profile may be a visual display of personal data associated with a specific user. Based on user preference and history data, in-vehicle infotainment system can generate corresponding user profile. A user profile can contain many different types of information on users such as personal identification information, home and work address, driving and traveling behavior, music and radio consumptions and so on. An in-vehicle infotainment system utilizes user profiles to adjust its configurations, such as music and radio playlists, GPS navigation recommendations, Phone call activities, etc., in order to provide vehicle drivers with comfort, convenient, and safe driving experience.

In-vehicle infotainment data consists of many user profiles that record all the information when using vehicles. Therefore, in-vehicle infotainment data can be used for various purposes, such as, predicting user travel purposes based on car route patterns, analyzing and recommending appropriate songs to the users based on their listening preferences, etc. Such data can be also used outside infotainment domain for purposes, for instance, performance testing, usability testing and academic research, etc.

Realistic in-vehicle infotainment data may not be readily available for public usage due to the concerns about privacy disclosure. For example, the in-vehicle infotainment data may contain a user's private information, like name, home location, and travel behaviors. The disclosure of such information may lead to the increase of potential theft of personal properties and other illegal activities and crimes. In order to create data-driven applications in vehicle infotainment domain and evaluate their performances, developing a synthetic in-vehicle infotainment data generation system can establish generalized synthetic data which covers composite information from various domains, e.g., music, radio, navigation, etc., and the system can generate customized data to match different purposes of applications.

While prior solutions to generate synthetic data mostly focus on one specific domain (e.g., music, movie, e-commerce and so on), and most of proposed datasets contain rich user explicit feedbacks, such as ratings, comments, like or dislike, etc., in-vehicle infotainment system usually collects composite information from different domains (e.g., GPS navigation, radio listen, music play, phone call, etc.), and it might not always ask users to give detailed feedbacks immediately, since in-vehicle infotainment system may not have the internet connectivity all the time and the storage used for the system is relatively limited. In addition, there are no widely accepted public realistic datasets available that can cover such various domains. Therefore, synthetic data generation system and methodology are needed to integrate data sources and background knowledge from different domains and produce composite context information as realistic as possible for different purposes of applications.

The present disclosure describes a synthetic data generation system and method that provides methods to generate a synthetic in-vehicle infotainment dataset by integrating relevant realistic data sources and knowledge from different domains to fulfil the requirements of in-vehicle infotainment systems. Such datasets may be utilized to help improve recommendation systems.

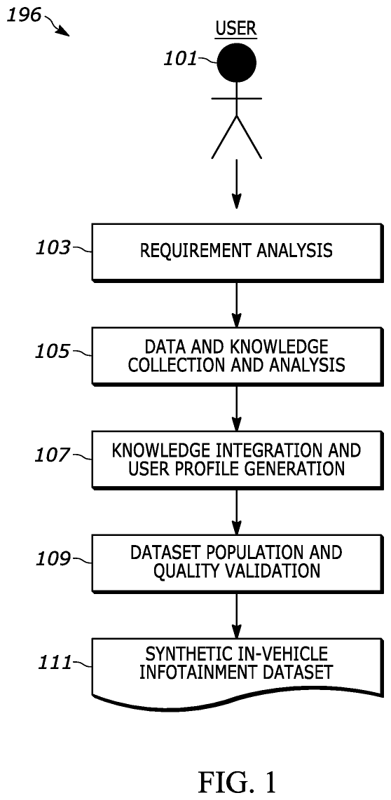

FIG. 1 shows the overall architecture implemented by the system. The system consists of the core components/steps that may analyze requirements of log data recorded when using in-vehicle infotainment systems, collect related realistic data sources and background knowledge from different domains in order to analyze user behaviors through data mining and statistical models, integrate learned knowledge and user behavior patterns into in-vehicle infotainment dataset along with generating user profiles. The system may populate instances and validate the quality of generated synthetic in-vehicle infotainment data.

At step 101, the requirement analysis may be the first step. The system user may start to understand the requirements of corresponding applications to determine the characteristics of log data of using in-vehicle infotainment systems. The requirement analysis step 101 may be done in consultation with software algorithms, artificial intelligence, domain experts, and system users. The characteristics of log data may include many information, for example, user information, music information, event information, radio information, route information, phone call information, etc. The coverage usually depends on the purposes and requirements of corresponding applications.

At step 103, the system and method may establish a requirement analysis of the in-vehicle infotainment system. The system may determine how software should operate for the in-vehicle infotainment system, especially with respect to the recommendation system of the IVIs. The system may analyze both data from the IVIs or offboard data to help with the requirement analysis. The requirement analysis may attempt to match a demographics or associated user.

One of the steps may include data population and evaluation at step 105. Based on the specifications of in-vehicle infotainment dataset and generated user profiles, the system may populate instances based upon the synthetic dataset. The values used in the datasets can be inherited from the original values in the source datasets or generated by statistical models and machine learning algorithms based on background knowledge.

For example, assuming the system modeled that people often leave home at 8:00 am and arrive the offices at 9:00 am, the system can use original models as instances but the system can also dynamically adjust the leaving time and arriving time by utilizing normal distributions with a specific range of average and variations, which results in adding noises over our initial models, e.g., leaving 7:53 am and arriving 9:07 am. In this manner, the system can allow users to determine and tune parameters in the models to produce more realistic datasets.

The system may utilize the collected data to generate a user profile at step 107. The collected data may indicate information and behaviors regarding certain users, such as travel patterns, listening habits, etc. The information may also be associated with a user based on information of age, gender, occupation, along with vehicle information. The vehicle information may include a car brand, type, color, etc. Once all the collected data and the user profiles are ready, they may be aligned and integrated on common fields and values. For example, travel history and music-listening history can have common timestamp fields (e.g., the stamp that shows arrivals to certain places and the that shows when a specific music song was played, etc.), which allows the system to generate music-listening history with geo-location information such as GPS coordinates, etc.

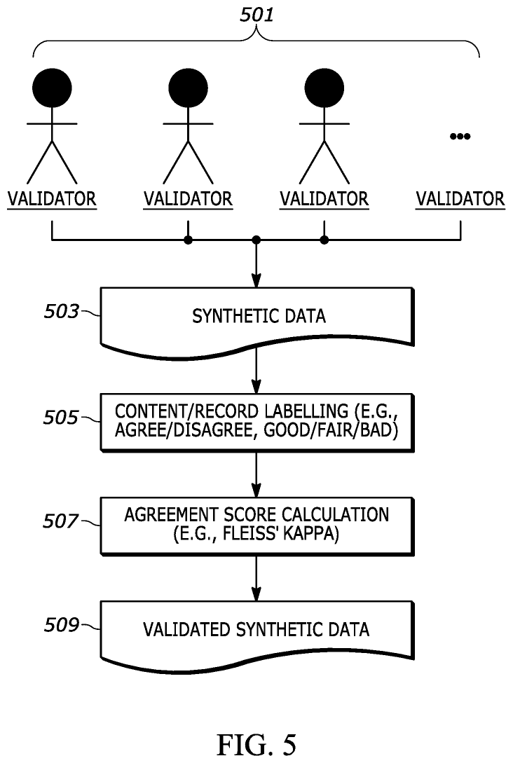

At step 109, the system may utilize the dataset population and quality validation. As explained in an embodiment of FIG. 5, the system may evaluate both the synthetic data to eliminate unrealistic data or inapplicable data. For example, some data that is retrieved may not be related to a vehicle setting. That data may need to be evaluated and eliminated for the generation of the final synthetic data.

At step 111, the system may generate the synthetic in-vehicle infotainment dataset. Thus, the data that is collected is matched with an associated user profile applicable to the user of the vehicle infotainment system. The data may also be coordinated with not only the user, but also with regards to a specific vehicle (e.g., make, model, year, etc.). The data may be coordinated also based on the specifications of the in-vehicle infotainment dataset. The dataset may be utilized to evaluate recommendation systems or to improve such systems. For example, radio recommendations may be applied to drivers based on their traveling patterns.

Many applications can be developed by using the generated synthetic in-vehicle infotainment data. One is using the synthetic in-vehicle infotainment data to evaluate recommendation algorithms. In one example, the system and method may focus on a scenario of radio recommendation for drivers based on their travelling patterns. For example, a driver may tend to listen radio about latest news or reports during morning hours of weekdays when he/she is driving the vehicle, while he/she prefers to listen radio about country music during weekends if he/she goes to a park with family members. After generating a machine learning model, system and method may apply the model on the test dataset and predicate the potential user behaviors and recommend users with proper radio list. The ranking algorithm can assign a score to each radio station in the list and output the top N results that have higher-ranking scores to users. Then the system and method can evaluate the performance of recommendation systems by comparing the output results and correct user activities in the testing data and finally generate the final reports.

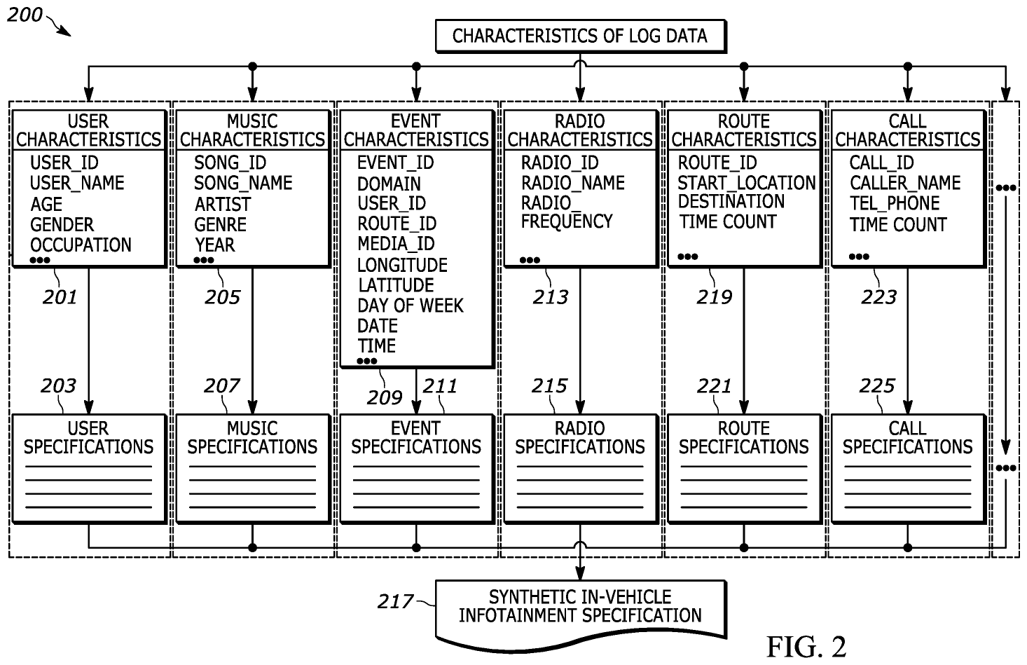

FIG. 2 shows an example of characteristics of different domains and characteristics of log data. For example, user characteristics explain some properties of user information. Each user has a unique ID that is used as a primary key to distinguish with other users. Each user may also need to provide first name, last name, age, gender, occupation, home address and so on. The user information can be used by in-vehicle infotainment system to accurately generate user profiles.

In addition, there are some possible characteristics of an event when using in-vehicle infotainment system. For example, an event may include temporal-spatial information, such as GPS's coordinates (longitude and latitude), day of week, date, and time. Each event can be categorized into a domain (e.g., music play, radio listen, phone call etc.), and an event should correlate to users, media and complete context information.

User characteristics 201 may be derived from the log data. The log data be deriving such characteristics based on a user identification, user name, age, gender, occupation, etc. A user specification 203 may be derived from the characteristics and the log data.

Event characteristics 209 may be derived from event identification, domain, user identification, route identification, media identification, longitude, latitude, day of week, date, time, etc. Based on such data, the event specification 211 may be derived and utilized in the synthetic in-vehicle infotainment specification 217.

Radio characteristics 213 may be derived from the log data, radio identification, radio name, radio frequency, etc. Based on such data, the radio specification 215 may be derived and utilized in the synthetic in-vehicle infotainment specification 217.

The route patterns or car trip information also can be utilized to improve and enrich the functionalities of in-vehicle infotainment systems. For example, in-vehicle infotainment systems may be expected to suggest appropriate radio station about traffic information to users when they may encounter a traffic jam in their route. After understanding all required information of different domains, the specifications of synthetic in-vehicle infotainment data can be finally generated.

Route characteristics 219 may be utilized to generate the synthetic in-vehicle infotainment specifications. Route characteristics 219 may include a route identification, start location, destination, time count, and other information. An algorithm or domain expert may be utilized to define the route characteristics in view of the log data.

Call characteristics 223 may be utilized and derived from the log data. Call specifications 225 may be derived from the log data to identify the caller identification (e.g., caller ID), caller name, telephone number, time count (e.g., call duration). Such information may indicate a preference to timing to call a contact or location of when to call a contact. The information may be utilized to define a call specification 225 for the in-vehicle infotainment system.

Media data and information may be retrieved from off-board sources (e.g., remote server) and categorized into different domains. For instance, playing music may be one the most popular activities when people use an in-vehicle infotainment system. A music or a song often can be identified using its unique ID and corresponding information, e.g., name, year, artist, genre, language and so on. Radio station also has its unique ID, name, frequency, etc.

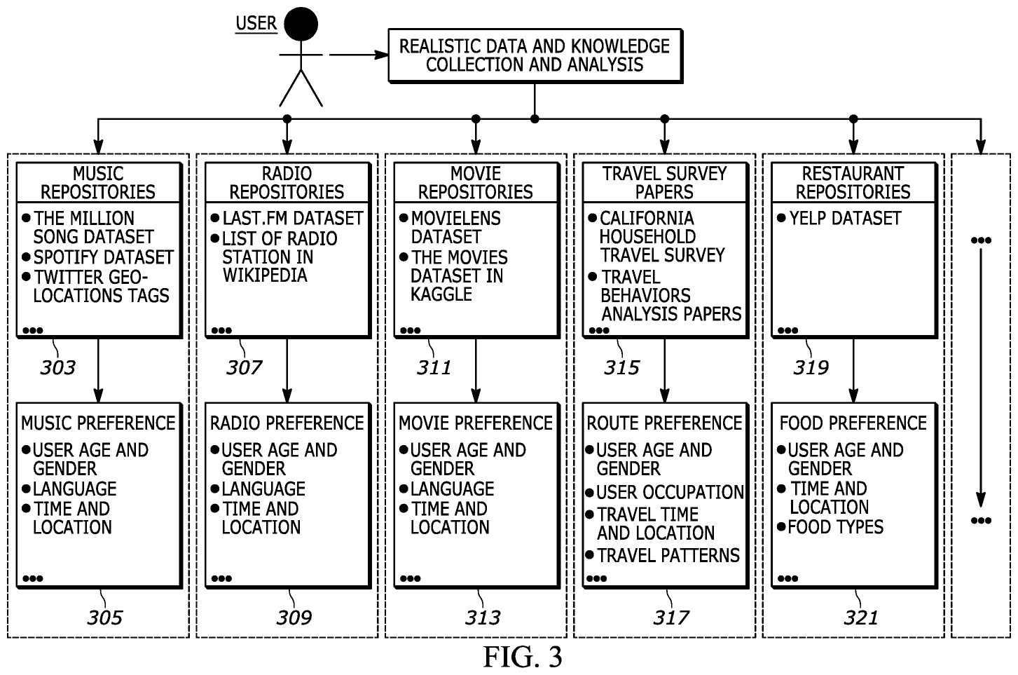

FIG. 3 shows an example process of related data and background knowledge collection and analysis. The realistic data may be collected from many different repositories. The data may be transferred via wireless connections or a wired connection. In one example, a music repository 303 may exist. The music repository 303 may include data from a million-song dataset, Spotify dataset, twitter geo-location tags, etc. The music repository 303 may thus identify music dataset related to playlists and various tracks and albums that are played by people. The music preference dataset 305 may show preferences related to tracks, songs, albums, that are played based on user age, and gender, language, time, and location.

One of the core components to the system and method described is the collection and analysis of relevant realistic data and background knowledge. After generating specifications or rules that define operation of in-vehicle infotainment dataset, the next step may be to determine if there are public datasets available that can be used or are similar to the in-vehicle infotainment dataset. If such datasets are available, we can collect existing datasets. For example, datasets collected from realistic users, real users, or datasets used by other similar applications that match similar specifications of the in-vehicle infotainment data may be utilized. If there are no realistic datasets available, the system can search for related online repositories and knowledge from research papers and surveys.

A dataset that contains composite information that describes in-vehicle infotainment systems may not exist in public. However, there are some datasets that focus on one specific domain, such as weather, music, radio, and movie and so on. This data may be accessed by a remote server that is not necessarily connected to the vehicle. In addition, there are some public surveys that provide insights of human behaviors when using different applications, such as understanding human travel purpose, daily activity, and restaurant preference. Even though their datasets might not be open for share due to the concern about privacy disclosure, the IVI can still use their patterns and results generated from their research as background knowledge to make the synthetic data more realistic. In addition, after collecting the realistic repositories, the data analysis process of each repository can produce useful user behavior patterns of using different media sources.

For example, music repositories and movie repositories that contain user-related knowledge and media-related knowledge are available and accessible online. These knowledge often include the preferences of users, i.e. music genre and movie type, with the different range of ages, gender, or geo-locations.

Further, surveys like California Household Travel Survey provide the statistics on people travel behaviors, purposes, and patterns by car, train, or bus, e.g., a typical route trip of a worker in a company usually starts from home to company in the morning time and leaves the company to a restaurant for lunch at noon.

As an example, data may indicate a pattern such as “after work time, he/she tends to go home or pick up children if there are kids in the household or go to the grocery and food warehouse.” Some research have found out that music preference may be impacted based on place of interests (POIs) and traffic states. In other word, in-vehicle infotainment systems may need to adapt its configuration based on the context (e.g., location information, GPS coordinates, etc).

The location and trajectory information also can be retrieved from offline maps or third-party online map services such as Google Maps and Mapbox by using their navigational features, e.g., the system can let users navigates between their home and workplaces and indirectly collecting their GPS coordinates to model trajectory patterns.

Finally, the preferences of media and the behavioral patterns of users can be directly surveyed using existing web survey platforms, such as SurveyMonkey and Amazon Mechanical Turks, or other crowdsourced data. In this way, these background knowledge can be utilized for modelling user behaviors as realistic as possible in in-vehicle infotainment systems. The preferences may also be surveyed by options on a user interface screen of the IVI indicating whether the user “likes” or “dislikes” the recommendation. In response to the data indicating that the user “likes” or “dislikes” the recommendation, the algorithm may adjust accordingly.

The radio repository 307 may include data and background knowledge related to listening habits of radio information. Such datasets may include Last.fm Dataset, radio station listings, Sirius XM App dataset, etc. The radio preferences 309 may show preferences related to radio listening habits, including age and gender, language, time, and location.

The movie repository 311 may include data and background knowledge related to listening habits of watching movies, television, digital video clips (e.g. Youtube), etc. Such datasets may include MovieLens dataset, Movies dataset in Kaggle, etc. The movie preferences 313 may include preferences related to watching habits of users, including age and gender, language, time, and location of those users.

The travel survey repository 315 may include data and background knowledge related to listening driving habits from various people, including driving behavior and routing preferences. Thus, such information may include which roads people prefer to drive, type of roads (e.g., HOV, residential, highway), and other information related to routing. Such datasets may include California household travel survey, travel behaviors analysis papers, etc. The route preferences 313 may include preferences related to watching habits of users, including age and gender, language, time, and location of those users.

The restaurant repository 319 may include data and background knowledge related to listening eating habits, including restaurant preferences. Thus, such information may include which restaurants certain people eat, at what times, which categories of restaurants, etc. Such datasets may include Yelp dataset, OpenTable dataset, and other similar repositories. The food preferences 321 may include preferences related to food and eating habits of users, including age and gender, language, time, and location of those users. Of course, while these repositories are shown as an example, extra repositories and preferences may be utilized for collecting datasets.

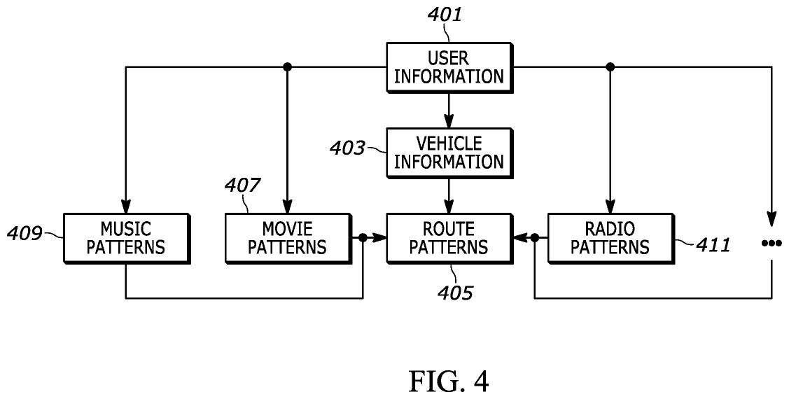

FIG. 4 discloses an example of a method of data integration and user profile generation. This may be a third step for data integration and user profile generation. Since the data generation system is aiming to establish an in-vehicle infotainment dataset, integrating process uses the routing and the trajectory patterns of the drivers as a core foundation of the datasets. Specifically, the system then integrates other relevant data. For example, user and vehicle information data may be used into user route patterns (e.g., a user with information of age, gender, and occupation drives a car with brand, type, color information and goes to some locations at specific time every weekday).

The system can then integrate user information and other media consumption patterns (e.g., a user with age, gender, occupation information likes to listen specific type of music) with spatial-temporal information and finally incorporates all information into the in-vehicle infotainment dataset and generate different user profiles. For this integration/incorporation process, common fields used across different datasets such as GPS coordinates or timestamps of the datasets can be used to interlink and align them, e.g., the music-listening histories can be logged using the timestamps and its coordinate, which can be aligned with travel histories which is often recorded using the coordinate and the timestamps as well, for example, if they share the same coordinate and timestamps, these datasets can be merged.

As an example of the integration, let us consider a statement describing the travel pattern below:

A female user aged around 25 and 40 may drive a car from home to a daycare to drop off the children at 8:00 in the morning. And then, the driver goes to the company for work around 8:30.

The example pattern then can be further detailed as follows:

A female driver of age between 25 and 40 likes to play kids songs when she drives from home to daycare in the morning time around 8:00 with her children. After drop off, she may like to listen pop music during her way to the company around 8:30.

The user profile may then now additionally include user daily trips, music listen histories, radio listen histories, vehicle information and other context information that in-vehicle infotainment system has recorded. In this way, the accuracy of generated synthetic data now becomes more accurate than the one generated from human-defined scratches. The description of the data in this example here is built using natural/human language description but it can be further formatted using the representation/format that machines can understand such as XML, JSON, and YAML, etc., so that the data can be automatically populated using computerized systems.

For example, several entities can be first modeled for systemically extract the information from the sentence and integrate them with relevant information. The method can consider modeling the entities such as User that describe user profiles (e.g., gender is female, age is 25-40, etc.) Media that describe genres and songs played by the IVI (e.g., any songs for Kids and Pop), RoutePattern that consists of the address and the GPS coordinates of the source, destination, and datetime for travels, etc. (e.g., a tuple can be used such as “(home, daycare, 8:00)”) and store them into any file formats or databases/knowledgebase systems for the next steps, etc.

The method or system may first gather user information 401. The user information may include data related to each user, including user age, gender, demographic information, occupation, name, etc. Next, the system may gather vehicle information 403. The vehicle information 403 may include details regarding the vehicle make, model, year, etc. At step 405, the system may gather information and data related to route patterns. The route patterns may include a time, location, places of interests, and other information associated with the route. For example, the time may associate with a start time, end time, or route time. The system may look at movie preference data 407 of users. The system may look to language of movies, type (e.g., category), time of viewing the movies or length of time for the movies, location of the movie, etc. The system may look at music pattern data 409. The music pattern data may include information on the language of music, genre, time that the music was played, location of the music, and other such music-related information. The system may also look to radio pattern data 411. Of course, other information may be collected and utilized, for example, weather data, calling data, and other information may be utilized and collected. Additionally, third party providers may provide local information (e.g., events or traffic data) to keep things up.

FIG. 5 illustrates the process of labelling process and agreement score calculation. In order to evaluate the quality of generated synthetic in-vehicle infotainment dataset. At step 501, the process may first determine context information that may be unrealistic based on the user profile and media consumption patterns. The process may utilize computing and artificial intelligence or even a human validator. In one scenario, the method may first ask at least three people (which may not be a domain expert) to go through the generated dataset independently. The people or AI model may focus on finding the context information that is obviously unrealistic including user profile and media consumption patterns. At step 505, the system may validate and label the data. In one scenario, each validator may receive a subset of synthetic data with same content, manually go through the content, and label each record with their comments (e.g., agree/disagree or good/fair/bad).

After all validators finish labelling process, the system may process agreement score calculation at step 507. The agreement score calculation can continue to compute the agreement score among validators. The feasible algorithm can be used for this process, e.g., the system can use Fleiss' Kappa in one embodiment. Fleiss' kappa is an example of a statistical measure for assessing the reliability of agreement between a fixed number of raters. At step 509, the system may validate the synthetic data. After the validation, the final synthetic dataset can be delivered and used for different purposes. Thus, the synthetic data set may be further reviewed to provide a more accurate dataset if necessary. In another scenarios, the synthetic dataset may not require review from an AI model or validators. In yet another embodiment, the AI model may utilize machine learning to determine the change in loss compared to ground truth data to improve the AI model.

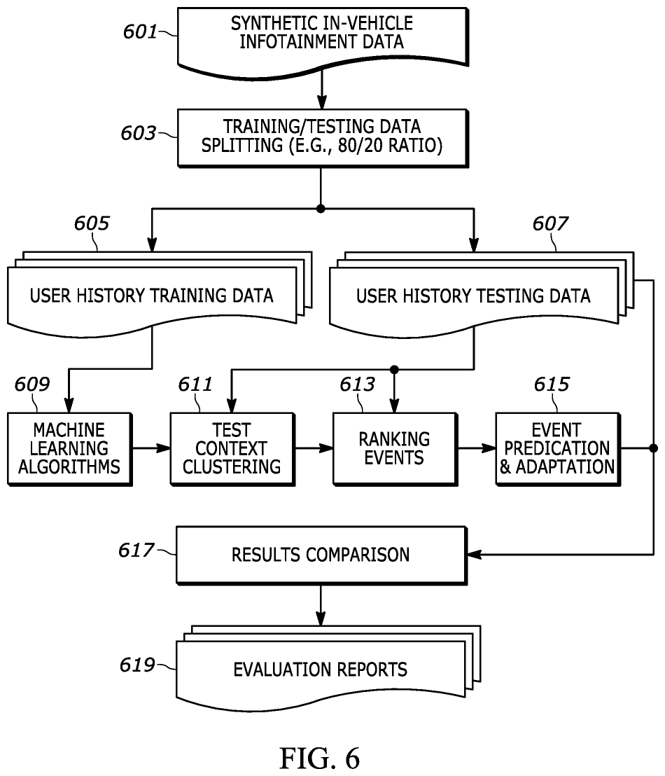

FIG. 6 illustrates an overview of the scenario that can utilize synthetic in-vehicle infotainment data for evaluating recommendation algorithms for IVI. The overview may be an example of an application of a recommendation system. At block 601, the system may be supplied with synthetic in-vehicle infotainment data. The system may then split the data into two via a certain split ratio such as 80/20 split ratio. In other words, 80% of the data will be user history training data 605 and 20% of the data will be user history test data 607, respectively. The ratio can be adjusted as needed.

The user history training data 605 may be used to be fed into machine learning algorithms 609 as input for its training. The algorithm here can be any machine learning algorithms which are newly developed for recommending entities such as music song or radio channels provided by IVI. For example, the algorithm can be any processes or logics that involve (1) clustering entities into different labeled groups and (2) rank them based on recommendation criteria where the entities can be event types (e.g., switch to other music songs or radio channels) and context information (e.g., time and location) in the user history training data. The resulted clusters and rankings are fed into the next blocks.

The next block labeled as test context clustering 611 cross-checks and evaluates the clusters from the previous step using the entities in user history testing data 611. For example, one of the potential evaluation criteria is to see whether context entities in the user history testing data can be aligned with or belonged to any of the clusters formed using user history training data. In other words, this block will evaluate the ability or the quality of clustering of the machine learning algorithms for recommendation.

The next block labeled as ranking events 613 evaluates the ability or the quality of rankings from the machine learning algorithms for recommendation. Similar to the previous block, the ranking results from the previous block are cross-checked and evaluated using the entities in user history testing data 611.

The next block labeled as event predication and adaptation 615 is an optional step that adapts the recommendation results from the machine learning algorithms if needed. For example, while a target machine learning algorithm could return more than 100 ranking results, users may only care about the top-5 results because they may not be able to check more than 100 results in actual recommendation scenarios. In that case, only top-5 results are selected from this step and passed to the next block.

Finally, the results on evaluation criteria such as clustering, ranking, and adaptations from machine learning algorithms for recommendations are compared and analyzed at block 617 to generation evaluation report 619 as output. The evaluation report may show data related to the comparison results. The evaluation report may indicate the number of suggestions or recommendations by the IVI, versus the number of dislikes or likes by the user. Thus, the evaluation report may determine how often the user prefers the suggestion of the recommendation system as opposed to disliking the suggestions. The evaluation report 619 may be utilized with Machine Learning Models to improve the recommendation systems suggestions.

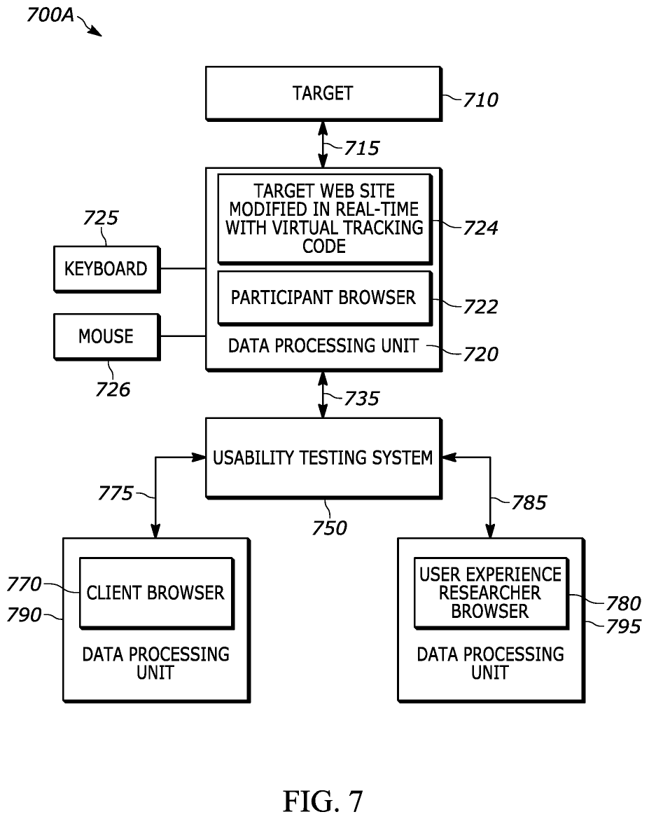

FIG. 7 is a simplified block diagram of a user testing platform 700A according to an embodiment of the present disclosure. Platform 700A is adapted to test a target 710, which may include an infotainment system, infotainment bench, vehicle, website application, etc. Platform 700A is shown as including a usability testing system 750 that is in communications with data processing units 720, 790 and 795. Data processing units 720, 790 and 795 may be a personal computer equipped with a monitor, a handheld device such as a tablet PC, an electronic notebook, a wearable device such as a cell phone, or a smart phone.

Data processing unit 720 includes a browser 722 that enables a user (e.g., usability test participant) using the data processing unit 720 to access target 710. Data processing unit 720 includes, in part, an input device such as a keyboard 725 or a mouse 726, and a participant browser 722. In one embodiment, data processing unit 720 may insert a virtual tracking code to target 710 in real-time while the target web site is being downloaded to the data processing unit 720. The virtual tracking code may be a proprietary JavaScript code, whereby the run-time data processing unit interprets the code for execution. The tracking code collects participants' activities, such as usage data on an infotainment system or on the downloaded web page such as the number of clicks, key strokes, key words, scrolls, time on tasks, and the like over a period of time. Data processing unit 720 simulates the operations performed by the tracking code and is in communication with usability testing system 750 via a communication link 735. Communication link 735 may include a local area network, a metropolitan area network, a wide area network. Such a communication link may be established through a physical wire or wirelessly. For example, the communication link may be established using an Internet protocol such as the TCP/IP protocol. Activities of the participants associated with target 710 are collected and sent to usability testing system 750 via communication link 735. In one embodiment, data processing unit 720 may instruct a participant to perform predefined tasks on the downloaded web site during a usability test session, in which the participant evaluates the web site based on a series of usability tests. The virtual tracking code (i.e., a proprietary JavaScript) may record the participant's responses (such as the number of mouse clicks) and the time spent in performing the predefined tasks. The usability testing may also include gathering performance data of the target web site such as the ease of use, the connection speed, the satisfaction of the user experience. Because the web page is not modified on the original web site, but on the downloaded version in the participant data processing unit, the usability can be tested on any web sites including competitions' web sites.

All data collected by data processing unit 720 may be sent to the usability testing system 150 via communication link 735. In an embodiment, usability testing system 750 is further accessible by a client via a client browser 770 running on data processing unit 790. Usability testing system 750 is further accessible by user experience researcher browser 780 running on data processing unit 795. Client browser 770 is shown as being in communications with usability testing system 750 via communication link 775. User experience research browser 780 is shown as being in communications with usability testing system 750 via communications link 785. A client and/or user experience researcher may design one or more sets of questionnaires for screening participants and for testing the usability of a web site. Usability testing system 750 is described in detail below.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for generating synthetic in-vehicle infotainment data, comprising:
receiving a plurality of preference data, wherein the preference data is associated with a plurality of domains that are associated with respective applications in an in-vehicle infotainment system;
receiving information related to an age or gender of a user of the in-vehicle infotainment systems,
utilizing the plurality of preference data and the information related to the age or gender of the user to generate one or more user profiles associated with the in-vehicle infotainment system; and
outputting a synthetic dataset to be utilized in a recommendation system of the in-vehicle infotainment system utilizing the one or more user profiles, wherein the synthetic dataset is associated with the one or more user profiles.

2. The method of claim 1, wherein the method further includes utilizing a machine learning model to generate one or more user profiles.

3. The method of claim 1, wherein the synthetic dataset is further analyzed by a plurality of validators in response to the synthetic data set being output.

4. The method of claim 1, wherein the plurality of domains includes a navigation domain, music domain, radio domain, movie domain, or restaurant domain.

5. The method of claim 1, wherein the method includes the steps of outputting an option to provide feedback in response to the outputting of the synthetic dataset utilized in the recommendation system.

6. The system and method of claim 1, wherein the preference data includes routing preference data received from a remote server not connected to the in-vehicle infotainment system.

7. The system and method of claim 1, includes the steps of receiving information related to a model or make of a vehicle utilizing the in-vehicle infotainment systems.

8. The system and method of claim 1, wherein the plurality of preference data is received from a remote server not connected to the in-vehicle infotainment system.

9. The system and method of claim 1, includes the steps of receiving information related to a model or make of a vehicle utilizing the in-vehicle infotainment system and utilizing the plurality of preference data and the information related to the model or make of the vehicle to generate one or more user profiles associated with the in-vehicle infotainment system.

10. The system and method of claim 1, wherein the synthetic dataset is associated with the preference data and the information related to the age or gender of the user.

11. A computer-implemented method of generating a dataset for an in-vehicle infotainment system, comprising:
receiving information related to a model or make of a vehicle utilizing the in-vehicle infotainment system;
receiving usage data associated with an in-vehicle infotainment system;
receiving a plurality of preference data, wherein the preference data is associated with a plurality of domains;
utilizing the plurality of preference data and usage data to generate one or more user profiles associated with the in-vehicle infotainment system; and
outputting a synthetic dataset to be utilized in a recommendation system of the in-vehicle infotainment system utilizing the one or more user profiles.

12. The method of claim 11, wherein a radio domain includes data associated with radio information retrieved from a radio website.

13. The method of claim 11, wherein the dataset includes music-listening history data associated with the timestamps.

14. A method of generating a synthetic dataset for an in-vehicle infotainment system, comprising:
receiving information related to a model or make of a vehicle utilizing the in-vehicle infotainment system;
receiving usage data associated with an in-vehicle infotainment system;
receiving a plurality of preference data from a plurality of remote servers not connected to the in-vehicle infotainment system, wherein the preference data is associated with a plurality of domains;
utilizing the plurality of preference data and usage data to generate one or more user profiles associated with the in-vehicle infotainment system; and
outputting a synthetic dataset to be utilized in a recommendation system of the in-vehicle infotainment system utilizing the one or more user profiles.

15. The method of claim 14, wherein user profile information categorizes a GPS navigation dataset and a radio listening dataset based upon an age and gender.

16. The method of claim 14, wherein the user profile information includes data associated with an occupation of the user.

17. The method of claim 14, wherein the step further includes utilizing the user profile in a recommendation system of the in-vehicle infotainment system.

18. The method of claim 14, wherein the user profile categorizes a global position system (GPS) navigation dataset and the radio listening dataset based upon a vehicle make and vehicle model.

19. The method of claim 14, wherein the method further includes outputting an evaluation report indicating results of recommendations of the recommendation system of the in-vehicle infotainment system.

20. The method of claim 14, wherein a synthetic dataset includes information associated with music of a location associated with the user.
